(19) United States
(12) Patent Application Publication
(10) Pub. No.: US 2003/0117802 A1
(43) Pub. Date: Jun. 26, 2003

(54) Integrated projector for discharge lamps

(75) Inventor: Mario De Sisti, Albano Laziale (IT)

Correspondence Address: Messrs., ARENT FOX, Suite 600, 1050 Connecticut Avenue, NW, Washington, DC, 20036-5339, US

(73) Assignee: DE SISTI LIGHTING S.p.A

(21) Appl. No.: 10/318,043

(22) Filed: Dec. 13, 2002

(30) Foreign Application Priority Data
Dec. 21, 2001 (IT) RM2001A000757
Dec. 21, 2001 (IT) RM2001A000669

(51) Int. Cl. F21V 29/00

(52) U.S. Cl. 362/264; 362/373

(57) ABSTRACT

The invention relates to an integrated projector for discharge lamps comprising a projector (1), including a discharge lamp, a support fork shaped structure for said projector, said fork shaped structure providing two substantially vertical elements (2, 3), provided laterally with respect to the projector, and a horizontal arm (4), joining said lateral elements (2, 3), in said substantially vertical elements of the fork shaped structure being provided all the elements of a voltage limiting system, or ballast, and in said horizontal arm (4) passing the electrical connection cables of the various components of the ballast provided in said two substantially vertical elements (2, 3), and arriving the power supply (5), between one of said substantially vertical elements of the fork shaped structure and the projector electrical connection means (6, 7) being provided.

The present invention relates to an integrated projector for discharge lamps.

More specifically, the invention concerns a projector of the above kind allowing to integrate in a single unit both the real projector and the ballast, thus avoiding the needing of providing the interconnection multipolar cable.

As it is well known, in the lighting engineering field discharge lamps (halide vapours) are widely used since many years, said lamps giving remarkable advantages with respect to the traditional incandescence lamps (filament lamps), such as a luminous efficiency (lumen:watt) three or four times higher than that can be obtained with filament lamps (some kinds of discharge lamps can reach almost a 100 lumen:watt ratio, while filament lamps at most have a luminous efficiency of 35 lumen:watt); a day light emission spectrum with a colour temperature between 4500 and 6500° K (Kelvin degrees), while filament lamps emit a spectrum with colour temperature at most of 3400° K chromatic features of the light emitted by discharge lamps make their use optimum in open environments, where there is a huge of solar light, since it is calorimetric compatible with the day light. In this way, possible colour correction or balancing intervention is simpler, said intervention being necessary to obtain optimum results when telecameras or motion-picture cameras are used as reading instruments, or for the pleasure of the image perception by the human eye.

Furthermore, the use of discharge lamps allows to have a luminance up to 20 times higher than that of the filament lamps, thus being possible to approach the idea of the punctiform light source, to optimise the optical system performances.

The professional lightening market has well received this kind of products, presented at the beginning of the 70s, and they can be now considered as a standard system.

For the use and the proper operation of the discharge lamps it is necessary a system strikes the voltaic arc when the lamp is switched on (igniter) and a voltage limitation system (known as ballast).

At present, lightening systems are comprised of the following elements:

a projector comprising the optical system, the lamp and the igniter;

a ballast, comprising the voltage limitation system and a series of electromechanical devices protection the system in case of de-coupling between projector and ballast;

an interconnection cable between projector and ballast, comprising a very flexible multipolar cable, to prevent breakage problems, that frequently occurs in the inner conductors, and two multipin connectors, respectively placed in the projector and the in the ballast.

Usually, choice criteria by the users of the discharge projectors presently available on the market are based on the following factors:

fixed costs on the material market products);

use variable cost: cost, lamp duration (hour cost), energy saving in view of the higher luminous efficiency and thus reduced power employed with respect to the filament lamps, electric distribution and arrangement costs;

reliability;

apparatus performances;

multiuse (possibility of use for more than one application).

As already said, powering systems for discharge lamps are presently comprised of a voltage limiting device, known as ballast, comprised within a suitably dimensioned metallic housing, and of a projector housing the lamp, the optical system and the switching on device (igniter).

The structure realised in this way has a series of problems well known to the users, such as the interconnection multipolar cable maximum length between projector and ballast (limited to 100 meters by most manufacturers), high cost of the interconnection systems, the use of forced ventilation for cooling the ballast, since they are usually used laid on the ground, the noise increasing with their use, etc.

These problems are presently solved either by adding various protection devices on the various elements comprising the system (with remarkable increase of costs, weight and dimensions), or by the professionality of the users who, knowing the limits imposed by the presently available systems, conform the arrangement respecting said constraints, often increasing costs and quickness and efficiency of the installation.

The solution as proposed according to the present invention allows obtaining an integrated projector so as to obtain advantages both in term of fixed costs and of variable costs, and of reliability and possibility of multiple use.

These and other results are obtained according to the invention by a solution providing the integration in a single apparatus of all the elements necessary for the proper operation of the discharge lamps (projector, ballast and interconnection cables), without the needing of dedicated distribution systems.

The solution suggested according to the present invention allows a suitable sizing of the ballast, that also has the function of supporting the housing of lamp, igniter and optical system, that consequently will no more take into consideration different lengths of the interconnection cables with the projector, since it is mounted contacting the same, thus noticeably improving the electromagnetic compatibility of the whole apparatus.

Furthermore, the solution according to the invention allows to avoid the passage of square wave forms on remarkably long cables, making any kind of installations easier and remarkably simplifying the use of this kind of apparatuses.

It is therefore specific object of the present invention an integrated projector for discharge lamps comprising a projector, including a discharge lamp, a support fork shaped structure for said projector, said fork shaped structure providing two substantially vertical elements, provided laterally with respect to the projector, and a horizontal arm, joining said lateral elements, in said substantially vertical elements of the fork shaped structure being provided all the elements of a voltage limiting system, or ballast, and in said horizontal arm passing the electrical connection cables of the various components of the ballast provided in said two substantially vertical elements, and arriving the power supply, between one of said substantially vertical elements of the fork shaped structure and the projector electrical connection means being provided.

Preferably, according to the invention, laterally with respect to said two substantially vertical elements a radiator element is provided for cooling the device.

Still according to the invention, a projector switching on/off button is provided.

Furthermore, according to the invention, an outward shielding is provided.

Always according to the present invention, an input circuit, having a power factor correction is provided.

Finally, according to the invention, said elements of the fork shaped structure are provided with a quick coupling system, for coupling and de-coupling from the projector.

The present invention will be now described, for illustrative but not limitative purposes, according to one preferred embodiment, with particular reference to the figure of the enclosed drawing, showing a perspective view of a preferred embodiment of an integrated projector according to the invention.

Observing now the enclosed figure, it is shown an embodiment of an integrated projector according to the invention, providing a discharge type projector 1 that, as already said, can be of any kind and power.

A fork shaped structure is mounted on said projector, said fork shaped structure being comprised of two lateral elements 2, 3, including all the components of a standard ballast, and an upper connection arm 4, through which the connection cables, and where the main power feeding 5 arrives.

Between element 3 of the ballast and the projector 1, a power connector 6 is provided, coupling with the connector 7 of the projector 1.

Two lateral radiators 8, 9 are provided on both the elements 2 and 3.

As already said, it is possible to realise said solution for each kind of projector, such as 125 W, 200W, 400W, 575W, 1200W, 2500W, 4000W, 6000W, 12000W projectors, and in any case for each discharge lamps presently available on the market or that will be put on the market in the future.

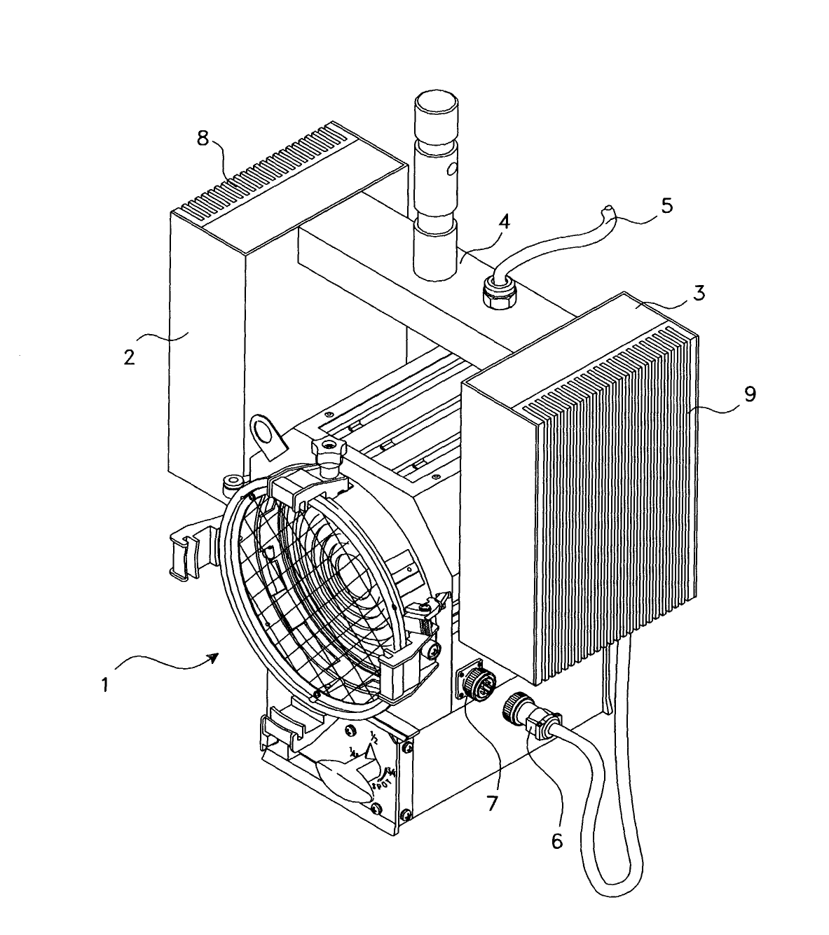

It is to be put into evidence the particular placement of the elements comprising the voltage limiting system (ballast), that, as it can be noted, is divided into two blocks, said blocks being integral part of the two vertical elements 2, 3 of the support fork shaped structure of the projector 1, as schematically shown in the FIG. 1.

Bearing in mind that projector 1 containing the lamp is ventilated by natural convection and designed to convey upward the hot air flow, the electronic components will be never influenced by the large thermal dissipation of the lamp.

Further, dissipating elements on which the power electronic components are mounted are in any case placed in such a way to guarantee an optimum thermal dissipation of the voltage limiting system (ballast).

By the solution suggested according to the present invention, that, as already said provides the integration of all the elements necessary for the proper operation of the discharge lamp, remarkable advantages are obtained with respect to devices having separated elements (separated projector, ballast and interconnection cable).

First of all, the solution suggested according to the present invention can be applied to each kind of projector, with each kind of optical system (Fresnel, Par, Softlight, Diffusion, etc.).

Furthermore, the solution allows to standardise the electrical connection and distribution system, since, not being more necessary to use multiple conductor interconnection cables, providing multipolar cables, even with large power (discharge lamps up to 18 kW are available on the market), the new system allows the use of standard cables and distribution systems, often available with the same final user, and in any case very easily available and cheap.

In this way, limits presently imposed to the projector with separated ballast are overcome, imposing to the various manufacturers to specify a maximum length of the interconnection cables between ballast and projector (maximum length indicated by most manufacturers is equal to 100 m), since said limitation is not imposed by the use of the solution according to the invention, it is possible to hypothise use and applications never taken into consideration.

The suggested solution allows having an optimum operation of the voltage powering and limitation device, that must no more take into consideration the possibility of having a variable load thanks to its integration and therefore proximity, with the projector. Furthermore, dissipating elements, on which the power electronics are mounted, carry out their function with a higher efficiency with respect to a separated ballast laid down on the ground, since the projector according to the invention, as the standard projector, is used at a certain height from the ground, and this particular makes it easier the creation of an air flow about the dissipating elements (this is not obtained with the dissipating elements laid down on the ground), thus optimising the cooling effect.

Another advantage of the solution according to the present invention is the improvement of the electromagnetic compatibility of the whole device. In fact, while in the systems having separated ballast and projector, mainly when they electronic ballast are used, it is very difficult to shield the interconnection cables, that are crossed by high, square wave form voltages, so that the users often are obliged to create passages dedicated to this kind of connections, with the consequent increase of working time, difficulty and costs.

On the contrary, the solution suggested according to the invention solves this problem from its root, since each electric power value different from the supply source is generated from inside the product, said product being suitably shielded outward.

By the inventive solution, a power factor correction is obtained. The voltage limiting system included inside the inventive projector provides an input circuit having a correction of the power factor (PFC). Therefore, the device does not introduce appreciable harmonic distortions on the power supply and makes it easier the sizing of the distribution systems. In case of distribution systems divided in three star phases (for example: 380V between each phase, 220V between phase and neutral phase), thanks to the power factor correction circuit, it is not necessary to oversize the conductor to the neutral if systems suitably divided on the three phases are supplied (balancing of the loads). This feature is noticeably advantageous even in case of use of power units to supply these systems.

An evident and very important advantage is the reduction of space, dimensions and weights. Integration of the ballast of the projector allows a remarkable reduction of the weight and the dimensions with respect to an equivalent standard system (separated projector, ballast and cable).

This feature is remarkably important for transport and storage of the apparatuses. In fact, in case of use of the lighting apparatus having discharge lamps on provisional structures, the fact that it is possible to transport more than one apparatus by the same means, thanks to the reduction of volume and weight, is that of being it possible to temporaneously store the object into small areas, thus making easier the work. Furthermore, this feature is surely appreciated by the rental company, renting apparatuses to the movie or TV production companies.

It is also obtained a remarkable increase of the reliability, due to a remarkable reduction of the number of movable electrical connections, of the optimum operating conditions (both thermal and electric conditions) of the electronics, of the best electromagnetic shielding outward and of the reduction of connection errors and compatibility errors between ballast and projector present in the standard systems.

By the solution suggested according to the invention, it is possible to transform a conventional system provided with separated ballast and interconnection cables in a system according to the invention; the new arrangement providing the ballast in the projector support (fork shaped support) can be applied to products already available on the market.

Among the features of the projector suggested according to the invention, it is provided the ease of assembling and disassembling the fork support/ballast group from the projector body, for high power projectors, in order to simplify the manoeuvrability of less heavy objects.

Assembling and disassembling operation is guaranteed by a mechanical quick release system allowing to easily couple or separate the fork support/ballast group from the projector body and by a quick operating connector for the electric parts.

Furthermore, the system is particularly noiseless, being it possible to avoid the use of fans, thus annulling the generation of acoustic noise, not only when the product is new.

In fact, present systems employing separated ballast, usually laid down on the ground, employ forced ventilation dissipation, combined with aluminium radiators, due to the low efficiency that the latter give in absence of a light air flow. It is true that said products, when brand new, are noiseless; but after some time, and after the use of the components in dusty, humid and with wide thermal variation environments, fans become very noise. Operation noiseless is very important for many kind of use, for example for use in the movie and TV field, where the image recording often occurs at the same time of the image recording.

By the conventional systems, often acoustic noise problems occur, obliging the users to put the ballast far from the set, always bearing in mind the limit of the length of the interconnection cables mentioned in the above, and also with remarkable increase of preparation time and costs.

It can be further easily understood that a remarkable reduction of the costs is obtained (direct costs), as well of the light arrangement costs and of their managing at the storing and transport level (indirect costs).

The solution according to the invention suggests a new technological approach allowing to save during the manufacturing many mechanical and electrical parts, no more necessary (very expensive components such as multipolar connectors according to army rules, very flexible multipolar interconnection cables, forced ventilation systems and their managing, etc.).

From the user point of view, the system according to the invention suggests a working procedure completely different and innovative with respect to the present one, privileging the quickness of the light arrangement preparation, safety, simplicity and low cost of the electric distribution, all features having a great economic and efficiency value.

Finally, remarkable advantages cannot be ignored for the handling and storing of these new systems with respect to the conventional ones.

The present invention has been described for illustrative but not limitative purposes, according to its preferred embodiments, but it is to be understood that modifications and/or changes can be introduced by those skilled in the art without departing from the relevant scope as defined in the enclosed claims.

1. Integrated projector for discharge lamps characterised in that it comprises a projector, including a discharge lamp, a support fork shaped structure for said projector, said fork shaped structure providing two substantially vertical elements, provided laterally with respect to the projector, and a horizontal arm, joining said lateral elements, in said substantially vertical elements of the fork shaped structure being provided all the elements of a voltage limiting system, or ballast, and in said horizontal arm passing the electrical connection cables of the various components of the ballast provided in said two substantially vertical elements, and arriving the power supply, between one of said substantially vertical elements of the fork shaped structure and the projector electrical connection means being provided.

2. Integrated projector for discharge lamps according to claim 1, characterised in that laterally with respect to said two substantially vertical elements a radiator element is provided for cooling the device.

3. Integrated projector for discharge lamps according to one of the preceding claims, characterised in that a projector switching on/off button is provided.

4. Integrated projector for discharge lamps according to one of the preceding claims, characterised in that an outward shielding is provided.

5. Integrated projector for discharge lamps according to one of the preceding claims, characterised in that an input circuit, having a power factor correction is provided.

6. Integrated projector for discharge lamps according to one of the preceding claims, characterised in that said elements of the fork shaped structure are provided with a quick coupling system, for coupling and de-coupling from the projector.

7. Integrated projector for discharge lamps according to each one of the preceding claims, substantially as illustrated and described.
